(19) United States
(12) Patent Application Publication
(10) Pub. No.: US 2003/0116473 A1
(43) Pub. Date: Jun. 26, 2003

(54) Method for hydrodesulfurization of light oil fraction

(76) Inventors: Ryutaro Koide, Toda-shi (JP); Hideo Tanaka, Toda-shi (JP); Yasuhito Goto, Toda-shi (JP)

Correspondence Address: BIRCH STEWART KOLASCH & BIRCH, PO BOX 747, FALLS CHURCH, VA, 22040-0747, US

(21) Appl. No.: 10/259,417

(22) Filed: Sep. 30, 2002

Related U.S. Application Data
(63) Continuation of application No. PCT/JP01/02652, filed on Mar. 29, 2001.

(30) Foreign Application Priority Data
Mar. 30, 2000 (JP) 2000-092571

(51) Int. Cl. C10G 45/60; C10G 47/00; C08F 4/02; B01J 31/00

(52) U.S. Cl. 208/217; 208/212; 208/111.35; 502/103

(57) ABSTRACT

A method for hydrodesulfurization which comprises introducing partially desulfurized oil, which is a light oil fraction containing sulfur, and hydrogen to a reactor packed with a hydrodesulfurization catalyst, wherein the partially desulfurized oil has a sulfur content of 2000 ppm or less and preferably a polycyclic aromatic compound content of 3 wt % or more, wherein the amount of hydrogen sulfide contained in the partially desulfurized oil and hydrogen introduced to the reactor is 1.5 mol % or less with respect to that of the hydrogen introduced, and wherein the hydrodesulfurization catalyst comprises a carrier comprising a porous inorganic oxide and also comprises tungsten and one of nickel and cobalt as a metal component supported on the carrier. The method allows the production of a desulfurized light oil having a sulfur content of 50 ppm or less without the use of a special crude oil, and under operation conditions providing high productivity.

### CROSS-REFERENCE

This application is a Continuation Application of International Application No. PCT/JP01/02652 which was filed on Mar. 29, 2001 claiming the conventional priority of Japanese patent Application No. 2000-092571 filed on Mar. 30, 2000.

### BACKGROUND OF THE INVENTION

1. Field of the Invention

The present invention relates to a hydrodesulfurization catalyst and hydrodesulfurization method for deeply desulfurizing a light oil fraction such as a straight run light oil fraction, catalytically-cracked gas oil, or thermally cracked gas oil to a sulfur content of 50 ppm or less, and particularly the content of polycyclic aromatic compounds to 2% or less; as well as to a reaction apparatus comprising the same.

2. Description of the Related Art

In conventional practice, a light oil fraction is hydrorefined by a method in which a catalyst obtained by supporting molybdenum, tungsten, nickel, cobalt, or another active material having hydrogenation capabilities on a porous inorganic carrier composed of alumina, silica-alumina, or the like is brought into contact with the light oil fraction. Heteroelements such as sulfur and nitrogen are removed from the light oil fraction by such hydrorefining.

A need for so-called gas oil deep desulfurization, in which the sulfur contained in gas oil is reduced to 500 ppm or less, has recently arisen due to concerns related to environmental preservation, and refining processes for the gas oil deep desulfurization have been established in line with emergent legislation. The following methods have been designed as processes for conducting the gas oil deep desulfurization: (1) two-step hydrogenation methods, (2) methods in which feed oil and hydrogen are brought into countercurrent contact in a lower-stage reaction column, and (3) methods in which hydrogen sulfide contained in an oil product of an upper-stage reaction column is removed in a gas-liquid separation tank, and the concentration of hydrogen sulfide fed to a lower-stage reaction column is then reduced.

It is also necessary to reduce the discharge of nitrogen dioxide and particulate matter from the exhaust gas of diesel engines. Further reducing the sulfur content of gas oil used as fuel thereof to 50 ppm or less enables sulfate production to be suppressed, the degradation of nitrogen oxide reducing catalysts to be controlled, and production of particulate matter on lower-stage treatment catalysts to be reduced. As a result, it is expected that nitrogen dioxide and particulate matter emissions into the atmosphere will be reduced. Furthermore, polycyclic aromatic compounds in the gas oil are believed to be the causative agents of the particulate matter, and reducing the content of polycyclic aromatic compounds to 2% or less may have an even better discharge-controlling effect.

Due to the aforementioned reasons, deep desulfurization should be conducted such that the sulfur content of gas oil is further reduced to 50 ppm or less, and the polycyclic aromatic compounds are further reduced to 2% or less. However, in conventional gas oil deep desulfurization, there is a limit to realizing such a low sulfur concentration, making it necessary to choose between operating conditions providing low productivity and crude oil with an extremely low sulfur content.

### SUMMARY OF THE INVENTION

The present invention is aimed at resolving the aforementioned problems, and an object of the present invention is to provide a method for hydrodesulfurization in which a high degree of desulfurization is possible due to hydrodesulfurization without the use of a special crude oil, and under operating conditions providing high productivity, to provide a hydrodesulfurization catalyst, and to provide a reaction apparatus comprising the same.

As a result of detailed examination of the relationship between the fractional sulfur content sought after when a light oil fraction is hydrorefined and the performance provided by the catalysts used, the inventors arrived at the present invention upon discovering that the optimal catalysts are different depending on whether the sulfur content is relatively high or low.

According to a first aspect of the present invention, a method is provided in which partially desulfurized oil, which is a light oil fraction, is hydrodesulfurized to produce a refined oil with a sulfur content of 50 ppm or less, wherein the method for hydrodesulfurization comprises providing a reactor packed with a hydrodesulfurization catalyst comprising a carrier formed of a porous inorganic oxide and also comprising tungsten and at least one of nickel and cobalt supported on the carrier; introducing hydrogen and sulfur-containing partially desulfurized oil into the reactor and performing hydrodesulfurization therein, wherein the sulfur content of the partially desulfurized oil is 2000 ppm or less, and the hydrogen sulfide concentration in the partially desulfurized oil and hydrogen is 1.5 mol % or less with respect to the hydrogen.

This method may also comprise hydrodesulfurization by the introduction of hydrogen and feed oil, which is a light oil fraction containing sulfur, into a reactor packed with an upper-stage hydrodesulfurization catalyst in order to obtain the partially desulfurized oil. In this case, the sulfur content of the feed oil may be 1% or greater, and the upper-stage hydrodesulfurization catalyst may include a carrier comprising a porous inorganic oxide, and molybdenum and at least one of nickel and cobalt as the metal components supported on the carrier. The polycyclic aromatic compound content of the feed oil can be 10% by weight or greater, in accordance with the method of the present invention. The method may also comprise reducing the hydrogen sulfide concentration by stripping the partially desulfurized oil obtained from the reactor packed with the upper-stage hydrodesulfurization catalyst. It is preferable that the content of polycyclic aromatic compounds in the partially desulfurized oil should be 3% by weight or greater, and the content of polycyclic aromatic compounds in the refined oil should be 2% by weight or less. The carrier may also contain silica-alumina.

According to a second aspect of the present invention, a hydrodesulfurization catalyst is provided for hydrodesulfurization of a light oil fraction, wherein the hydrodesulfurization catalyst comprises a carrier formed of a porous inorganic oxide, and tungsten and at least one of nickel and cobalt supported on the carrier, and wherein the catalyst is used to perform hydrodesulfurization whereby partially desulfurized oil comprising a light oil fraction with a sulfur content of 2000 ppm or less is desulfurized into refined oil with a sulfur content of 50 ppm or less, such that the hydrogen sulfide contained in the partially desulfurized oil and hydrogen introduced to the hydrodesulfurization is 1.5 mol % or less with respect to the hydrogen. This catalyst is preferable for the hydrodesulfurization method of the present invention.

According to a third aspect of the present invention, a reaction apparatus for hydrodesulfurization of a light oil fraction is provided, wherein the reaction apparatus for hydrodesulfurization comprises an upper-stage reactor packed with a catalyst comprising a carrier formed of a porous inorganic oxide, and molybdenum and at least one of nickel and cobalt supported on the carrier; a lower-stage reactor packed with a catalyst comprising a carrier formed of a porous inorganic oxide, and tungsten and at least one of nickel and cobalt supported on the carrier; a stripping apparatus which is disposed between the upper-stage reactor and the lower-stage reactor and reduces the content of hydrogen sulfide in the partially desulfurized oil obtained from the upper-stage reactor; and a hydrogen feed apparatus which feeds hydrogen to the upper-stage reactor and the lower-stage reactor, respectively. Even feed oil with a sulfur content of 1% or greater supplied to this reaction apparatus can be desulfurized to refined oil with a sulfur content of 50 ppm or less.

### BRIEF DESCRIPTION OF THE DRAWINGS

FIG. 1 is a block diagram of the hydrodesulfurization reaction apparatus used in the examples of the present invention.

### DESCRIPTION OF THE PREFERRED EMBODIMENTS OF THE INVENTION

Light Oil Fraction

The light oil fraction used in the present invention is preferably a straight run light oil fraction, and may either be a straight run light oil fraction alone or a mixed light oil fraction in which light thermally cracked gas oil or light catalytically-cracked gas oil has been mixed with a straight run light oil fraction. This straight run light oil fraction is obtained by atmospheric distillation of crude oil, of which the approximate 10% distillation point is between 240-280° C., the 50% distillation point is between 280-320° C., and the 90% distillation point is between 330-370° C. The boiling points and distillation points are determined by the JIS K 2254 “Fuel Oil Distillation Test Method” unless particularly indicated otherwise.

“Thermally cracked oil” refers to light cut oil obtained by a reaction in which heat is applied to heavy oil fractions and in which a radical reaction constitutes the main element; that is, refers to fractions obtained, for example, by delayed coking, visbreaking, fluid coking, or the like. All the fractions thus obtained may be used as thermally cracked oil for these fractions, but it is preferable to use fractions with a distilling temperature of 150-520° C.

“Catalytically-cracked oil” refers to a fraction obtained during catalytic cracking of middle distillate products or heavy fractions, particularly vacuum distillation fractions and the like, with a zeolitic catalyst, and particularly to a cracked light oil fraction obtained as a byproduct in a fluidized catalytic cracking apparatus designed to manufacture high-octane gasoline. Of these fractions, light catalytically-cracked oil with a relatively low boiling point and a heavy catalytically-cracked oil with a relatively high boiling point are generally obtained separately. Any of these fractions can be used in the present invention, but it is preferable to use the former (light catalytically-cracked oil, or so-called light cycle oil (LCO)). Generally, the 10% distillation point of LCO is within the range of 220-250° C., the 50% distillation point is between 260-290° C., and the 90% distillation point is between 310-355° C. The 10% distillation point of heavy catalytically-cracked oil, or so-called heavy cycle oil (HCO), is between 280-340° C., the 50% distillation point is between 390-420° C., and the 90% distillation point is 450° C. or greater.

Feed Oil

The aforementioned light oil fraction with a sulfur content of 1% or greater is used for the feed oil employed in the present invention. Feed oil commonly has a sulfur content of 1-5%, a nitrogen content of 50 ppm or greater, particularly 100-500 ppm, and a specific gravity of 0.80 or greater, particularly 0.82-0.92. The content of polycyclic aromatic compounds (polycyclic aromatic compound content) having two or more rings is 3-20% by weight. In the present specification, the sulfur content is determined by the method for measuring sulfur content according to ASTM D2622, and the aromatic content is measured in conformity with IP 391.

Partially Desulfurized Oil

The partially desulfurized oil used in the present invention may be the aforementioned light oil fraction with a sulfur content of 2000 ppm or less, a light oil fraction with the sulfur content thereof reduced to 2000 ppm or less by subjecting the aforementioned feed oil to hydrodesulfurization or other means, or the like. It is preferable to use partially desulfurized oil with a sulfur content of 100-2000 ppm, and particularly 100-1000 ppm. The polycyclic aromatic compound content is preferably 3-20% by weight, and particularly 3-10% by weight.

Lower-stage Catalyst

The hydrodesulfurization catalyst (also referred to hereinbelow as a “lower-stage catalyst”) used in hydrorefining partially desulfurized oil comprises a carrier composed of a porous inorganic oxide, and tungsten and at least one of nickel and cobalt as metal components supported on the carrier. Any one of or a combination of the elements phosphorous, boron, and fluorine may be used as other components.

The lower-stage catalyst preferably has a specific surface area of 100-450 m²/g, particularly 150-300 m²/g, a pore volume of 0.1-2 cm³/g, particularly 0.2-1.5 cm³/g, and a median pore diameter of 3-20 nm, particularly 4-10 nm, and more specifically 4-7 nm. The shape of the catalyst is preferably that of a sphere, a cylinder, a trilobe, or a quadrilobe. The cross-sectional dimensions thereof may be set at 0.1-10 mm, and preferably at 0.7-3 mm.

The pore characteristics in the present invention can be measured by nitrogen gas adsorption method, and the relationship between the pore volume and pore diameter can be calculated by BJH method or the like. The pore volume indicates the volume of pores within a range of 2-30 nm. The median pore diameter is defined as the pore diameter measured when the cumulative pore volume calculated starting from the large pore diameters reaches V/2, where V represents the pore volume obtained under conditions corresponding to a relative pressure 0.9667 in the nitrogen gas adsorption method.

Oxides of elements in Groups 2, 4, 13, or 14 of the periodic table may be used as porous inorganic oxides (1990 periodic table recommended by IUPAC). Among these, silica, alumina, magnesia, zirconia, boria, calcia, and the like are preferred, and these may be used alone or in combinations of two or more. Alumina (having crystal structures such as γ, δ, η, and X), silica-alumina, silica, alumina-magnesia, silica-magnesia, and alumina-silica-magnesia are preferred. Furthermore, silica-alumina, particularly amorphous silica-alumina, should preferably be added. The silica-alumina portion should preferably be added in an amount of 60% by weight or greater in relation to the weight of the lower-stage catalyst. The composition of the carrier comprising silica-alumina should have an Si/Al (molar ratio) within a range of 0.02-4.00, preferably 0.05-2.00, and particularly 0.8-1.50. The Si/Al content (molar ratio) referred to in the present specification is calculated as the ratio of the number of silicon and aluminum atoms contained in the entire carrier.

The pore distribution of the carrier used in the lower-stage catalyst preferably has a median pore diameter of 2.5 nm-6 nm, and more preferably 3 nm-5.5 nm. A range of 3.5 nm-5 nm is especially preferable. The carrier needs to have a large surface area, so the surface area of the carrier should preferably be 400 m²/g or greater. The carrier should have a pore volume of 0.3-1.5 cm³/g, specifically 0.4 cm³/g or greater, and especially 0.5 cm³/g or greater, to allow a large number of metal components to be supported.

Tungsten may be added as a metal component, and the content thereof should preferably be 5-30% by weight, and particularly 10-25% by weight, in terms of the metal element. Molybdenum and other Group 6 metal elements of the periodic table may also be added, in which case the proportion of tungsten in relation to the Group 6 metal elements should preferably be 60% by weight or greater, particularly 80% by weight or greater, and specifically 95% by weight or greater, in terms of metal element weight. It is preferable that either or both the elements nickel and cobalt should be added as other metal components, and the total content thereof should be 1-10% by weight, and particularly 2-8% by weight, in terms of metal elements. The proportion of nickel in relation to nickel and cobalt should be 60% by weight or greater, particularly 80% by weight or greater, and specifically 95% by weight or greater, in terms of metal element weight. Any one or a combination of the elements phosphorus, boron, and fluorine may be used as other components, and the total content thereof should be 1-10% by weight, and particularly 2-6% by weight, in terms of metal element weight. Noble metals such as platinum may also be added as other metal components, but a substantial absence of noble metals is preferred.

Lower-stage Hydrodesulfurization

The hydrorefining method of the present invention is conducted under conditions in which the concentration of hydrogen sulfide in the aforementioned partially desulfurized oil and hydrogen is 0.015 mol or less (that is, 1.5 mol % or less), preferably 0.001-0.01 mol (0.1-1 mol %), and more preferably 0.002-0.01 mol (0.2-1 mol %), per mole of the hydrogen introduced. Normally, the hydrodesulfurized partially desulfurized oil contains hydrogen sulfide, and the hydrogen sulfide must be removed therefrom by stripping or the like prior to the lower-stage hydrodesulfurization. The hydrogen sulfide in the hydrogen must also be removed. The concentration of other impurities such as ammonia should be 0.1 mol % or less, and particularly between 0.001-0.1 mol %, with respect to the introduced hydrogen. The sulfur content of the refined oil thus obtained can be reduced to 50 ppm or less, particularly to 40 ppm or less, and specifically to 35 ppm or less. The nitrogen content can be reduced to 10 ppm or less, and particularly to 5 ppm or less.

The reaction conditions of the lower-stage hydrodesulfurization should preferably be as follows: temperature of 250-500° C., and particularly 300-400° C.; pressure of 1-30 MPa, particularly 3-20 MPa, and more specifically 4-10 MPa; hydrogen oil ratio of 50-2000 NL/L, particularly 100-1000 NL/L, and more specifically 150-500 NL/L; and liquid hourly space velocity (LHSV) if 0.1-10 hr⁻¹, particularly 1-8 hr⁻¹, and more specifically of 3-6 hr⁻¹.

Upper-stage Hydrodesulfurization

The upper-stage hydrodesulfurization method of the present invention involves mixing the upper-stage catalyst with the aforementioned feed oil in the presence of hydrogen, whereby partially desulfurized oil is obtained. The sulfur content of the resulting partially desulfurized oil can be reduced to 2000 ppm or less, particularly to 100-2000 ppm, and more specifically to 100-1000 ppm.

The reaction conditions of the upper-stage hydrodesulfurization should preferably be as follows: temperature at 250-500° C., and particularly 300-400° C.; pressure at 1-30 MPa, particularly 3-20 MPa, and more specifically 4-10 MPa; hydrogen oil ratio at 50-2000 NL/L, particularly 100-1000 NL/L, and more specifically 150-500 NL/L; and liquid hourly space velocity (LHSV) at 0.1-10 hr⁻¹, particularly 1-8 hr⁻¹, and more specifically at 3-6 hr⁻¹.

Upper-stage Catalyst

The upper-stage hydrodesulfurization catalyst (also referred to hereinbelow as an “upper-stage catalyst”) of the present invention comprises a carrier composed of a porous inorganic oxide, and molybdenum and nickel (Mo/Ni) or molybdenum and cobalt (Mo/Co) as metal components supported on the carrier.

The upper-stage catalyst should preferably have a specific surface area of 100-450 m²/g (particularly 150-300 m²/g), a pore volume of 0.1-2 cm³/g (particularly 0.3-1.5 cm³/g), and a median pore diameter of 3-20 nm (particularly 4-10 nm, and more specifically 5-9 nm). The shape of the catalyst is preferably that of a sphere, a cylinder, a trilobe, a quadrilobe, or the like. The cross-sectional dimensions thereof may be set at 0.1-10 mm, or preferably at 0.7-3 mm.

Oxides of elements in Groups 2, 4, 13, or 14 of the periodic table may be used as porous inorganic oxides (1990 periodic table recommended by IUPAC). Among these, silica, alumina, magnesia, zirconia, boria, calcia, and the like are preferred, and these may be used alone or in combinations of two or more. Alumina (having crystal structures such as γ, δ, η, and X), silica-alumina, silica, alumina-magnesia, silica-magnesia, and alumina-silica-magnesia are preferred.

Molybdenum may be added as a metal component, and the content thereof should preferably be 5-20% by weight, and particularly 8-15% by weight, in terms of the metal element. Tungsten and other Group 6 metal elements of the periodic table may also be added, in which case the proportion of molybdenum in relation to the Group 6 metal elements should preferably be 60% by weight or greater, particularly 80% by weight or greater, and specifically 95% by weight or greater, in terms of metal element. Either or both the elements nickel and cobalt may be added as other metal components, and the total content thereof should be 1-10% by weight, and particularly 2-6% by weight, in terms of metal elements. Any one or a combination of the elements phosphorus, boron, and fluorine may be used as other components, and the total content thereof should be 1-10% by weight, and particularly 2-6% by weight, in terms of metal element.

Method for Manufacturing Hydrodesulfurization Catalyst

The method for manufacturing the upper-stage and lower-stage catalysts preferably consists of supporting metal components on a carrier as described below. Although the method for manufacturing the carrier used in the present invention is not particularly defined, it is preferable to use methods in which inorganic hydrous oxides are produced by coprecipitation, kneading, or the like; the resulting material is formed; and the formed article is dried or calcinated.

Although the method of supporting the metal components is not particularly limited, it is preferable to employ the commonly used spray impregnation methods, immersion methods, or the like. To control the state in which the metals are supported, it is preferable to adopt an arrangement in which an organic compound, an organic salt, or the like is also added to the metal-carrying solution. Hydroxycarboxylic acids such as citric acid, malic acid, and tartaric acid are preferred as such organic compounds. The metal-containing solution is dried for between 10 minutes and 24 hours at a temperature of 50-180° C., and particularly at 80-150° C., preferably after being impregnated with all the metal components. The calcination process is performed at 400-600° C., particularly at 450-580° C., the time required to raise the temperature to the calcinating level is preferably 10-240 minutes, and the holding time at the calcination temperature is preferably 1-240 minutes. This type of calcination allows organic compounds and the like in the metal-carrying solution to be removed, and brings the organic matter in the catalysts to a level of 0.5% by weight or less in terms of carbon weight.

Reactor

A conventional reactor used in petroleum refining can be used in the present invention, but a particularly preferable embodiment comprises an apparatus or process for reducing the content of hydrogen sulfide in the oil and gas after the upper-stage desulfurization reaction. The apparatus for reducing the concentration of hydrogen sulfide is not particularly defined, but a gas-liquid contact apparatus or the like disposed inside the reactor may be used; or a scrubbing tower, absorption tower, or the like disposed outside the reactor may be also used. It is also possible to use methods in which the hydrogen sulfide concentration of partially desulfurized oil and hydrogen is reduced by extracting part of the hydrogen containing the hydrogen sulfide, or by stripping the oil produced during the preceding stage. Although the lower-stage reactor can be operated by bringing the hydrogen and partially desulfurized oil into contact with each other either as countercurrents or parallel currents, the present invention allows adequate desulfurization to be achieved by cocurrent contact. The hydrorefining apparatus disclosed in International Publication WO00/42130 (International Application No. PCT/JP00/00147) can be used as the reactor.

A catalyst packing machine may be used to pack the catalyst into the reactor in order to maintain efficient gas-liquid contact in the catalyst layer. The surface of the catalyst layer in the reactor can be made substantially level during packing by the use of the packing machine, which not only prevents the fluid from channeling in the catalyst layer and hot spots which are believed to result from such channeling from being generated, but also exerts a favorable influence on the catalyst activity and catalyst duration due to dense packing of the catalyst in the reactor. The difference in temperature measured at a plurality of locations in the horizontal surface in the catalyst layer should be 10° C. or less, and particularly 5° C. or less.

In the hydrorefining conditions according to the present invention, a high calorific value is developed during hydrodesulfurization reactions involving sulfur compounds in feed oil, hydrogenation reactions involving aromatics, and the like, making it very likely that the catalyst layer in the reactor will be exposed to a rapid increase in temperature as a result of the heat release. This temperature increase causes polycyclic aromatic compounds to be produced, the color of the oil product to be adversely affected as a result of this production, catalyst activity to be reduced, catalyst life to be shortened, and the like. In view of this, the present invention can be implemented using a reactor commonly employed in hydrorefining as the hydrorefining reaction apparatus, but it is preferable to divide the catalyst layer in the reactor into a plurality of beds as needed and to feed hydrogen between the beds as needed in order to effectively prevent an increase in temperature such as that described above. The temperature difference between the inlet and outlet in the upper-stage desulfurization reactor should be 60° C. or less, and particularly 50° C. or less. The temperature difference between the inlet and outlet in the lower-stage desulfurization reactor should be 30° C. or less, and particularly 20° C. or less.

### EXAMPLES

The present invention is described in greater detail through examples, but the present invention is not limited thereby.

Preparation of Upper-stage Catalyst

An aqueous solution prepared by dissolving 38.2 g of ammonium molybdate, 14.7 g of phosphoric acid, 30 g of citric acid, and 13.2 g of cobalt carbonate in 150 g of a porous silica-alumina carrier formed into a cylinder 1.3 mm in diameter and 2-3 mm in length (Si/Al molar ratio: 0.04, specific surface area: 309 m²/g, pore volume: 0.630 cm/g, median pore diameter: 7.8 nm) was diluted to an amount equal to the water absorbed on the carrier, and the total amount thereof was spray-impregnated and then dried for 6 hours at 130° C. The temperature was then raised to 550° C. over a period of 30 minutes, and the material was calcined at the same temperature for 30 minutes, yielding catalyst A. Catalyst A included as element weight 11% by weight of Mo, 3% by weight of Co, and 2% by weight of P. When measured by the nitrogen desorption method, the specific surface area was 220 m²/g, the pore volume 0.435 cm³/g, and the median pore diameter 6.8 nm.

Preparation of Lower-stage Catalyst

An aqueous solution prepared by dissolving 85.0 g of ammonium metatungstate in 150 g of a porous silica-alumina carrier formed into a cylinder 1.3 mm in diameter and 2-3 mm in length (Si/Al molar ratio: 1.24, specific surface area: 459 m²/g, pore volume: 0.596 cm³/g, median pore diameter: 4.6 nm, content of amorphous silica-alumina: approximately 80% by weight, balance: γ-alumina) was diluted to an amount equal to the water absorbed on the carrier, and the total amount thereof was spray-impregnated and then dried for 6 hours at 130° C. An aqueous solution (same amount as the water absorbed on the carrier) prepared by dissolving 30.3 g of nickel nitrate hexahydrate was then spray-impregnated and dried for 6 hours at 130° C. The temperature was then raised to 550° C. over a period of 30 minutes, and the material was calcined at the same temperature for 30 minutes, yielding catalyst B. Catalyst B contained 22% by weight of W and 4% by weight of Ni. When measured by the nitrogen desorption method, the specific surface area was 205 m²/g, the pore volume 0.310 cm³/g, and the median pore diameter 5.3 nm.

Properties of Feed Oil

The feed oil used in the examples is a straight run light oil fraction obtained by the atmospheric distillation of Middle-Eastern crude oil, and the properties thereof are shown in Table 1.

TABLE 1

| | Unit | Feed Oil Properties |
|---|---|---|
| Sulfur Content | % by weight | 1.55 |
| Nitrogen Content | ppm | 120 |
| Polycyclic aromatic compounds | % by weight | 14.5 |
| Specific Weight (15/4° C.) | — | 0.8573 |
| Viscosity at 30° C. | mm²/s | 5.9 |
| Cetane Value | — | 55 |
| 10% Distillation Point | ° C. | 271 |
| 90% Distillation Point | ° C. | 350 |

Upper-stage Desulfurization Reaction

Partially desulfurized oil was obtained by packing a reactor 30 mm in diameter and 1 m in length with 100 mL of a catalyst and applying hydrotreatment under the reaction conditions shown in Table 2. The temperature difference between the inlet and outlet of the reactor was 5° C. or less. The purity of the hydrogen used was 99.99% or greater, and the hydrogen sulfide concentration was 10 ppm or less.

TABLE 2

| | |
|---|---|
| Hydrogen Pressure | 5 MPa |
| LHSV | 4.0 hr⁻¹ |
| Hydrogen Flow Rate | 200 NL/L |
| Reaction Temperature | 350° C. |

Hydrogen Sulfide Reduction Treatment

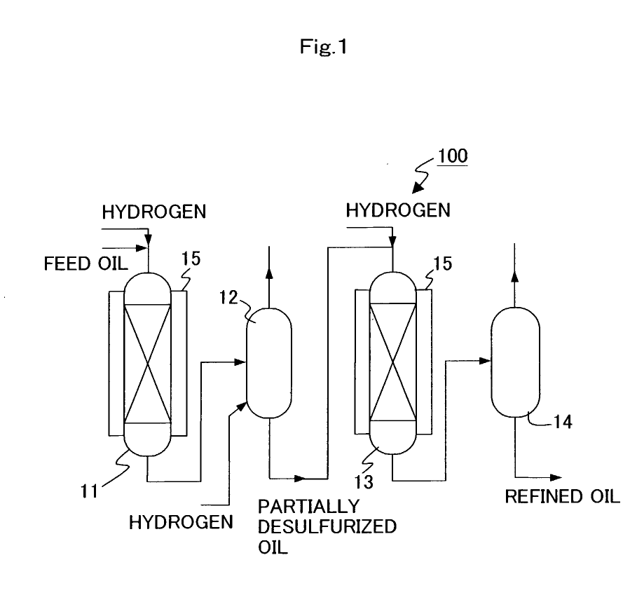

In the examples and some of the comparative examples, partially desulfurized oil refined by an upper-stage desulfurization reaction was stripped using a stripping apparatus to extract some of the gas components. The hydrogen sulfide concentration of the oil introduced lower-stage was thus reduced. FIG. 1 shows a desulfurization reaction apparatus 100 comprising a reactor for upper-stage desulfurization reactions, a stripping apparatus, and a lower-stage desulfurization reaction apparatus.

Feed oil is introduced together with hydrogen into a reactor for upper-stage desulfurization reactions 11, and the product thereof is introduced into a stripping apparatus 12. Hydrogen is introduced into the stripping apparatus 12, and partially desulfurized oil from which hydrogen sulfide and other gas impurity components contained in the product have been removed is obtained from the bottom of the stripping apparatus 12. The resulting partially desulfurized oil is introduced together with hydrogen into a lower-stage desulfurization reaction apparatus 13. The product thereof is introduced into a high-pressure separation tank 14, gas components such as hydrogen are removed, and refined oil is obtained from the bottom thereof. Heaters 15 for controlling the reaction temperature are provided to the reactor for upper-stage desulfurization reactions 11 and to the lower-stage desulfurization reaction apparatus 13.

Lower-stage Desulfurization Reaction

Partially desulfurized oil was obtained by packing a reactor 30 mm in diameter and 1 m in length with 100 mL of a catalyst and applying hydrotreatment under the reaction conditions shown in Table 3. The temperature difference between the inlet and outlet of the reactor was 5° C. or less. The purity of the hydrogen used was 99.99% or greater, and the hydrogen sulfide concentration was 10 ppm or less.

TABLE 3

| | |
|---|---|
| Hydrogen Pressure | 5 MPa |
| LHSV | 4.0 hr⁻¹ |
| Hydrogen Flow Rate | 200 NL/L |
| Reaction Temperature | 350° C. |

### Example 1

100 mL of catalyst A was packed upper-stage and 100 mL of catalyst B was packed lower-stage. An upper-stage desulfurization reaction was conducted using feed oil, after which hydrogen sulfide reduction treatment was applied, and a lower-stage desulfurization reaction was conducted. The sulfur concentrations in the obtained partially desulfurized oil and refined oil are shown in Table 4. Table 4 also uses mol % to show the concentration of hydrogen sulfide contained in the hydrogen and partially desulfurized oil introduced into the lower-stage reactor, as well as the concentration of ammonia contained in the hydrogen and partially desulfurized oil introduced into the lower-stage reactor.

### Comparative Example 1

100 mL of catalyst A was packed upper-stage and another 100 mL of catalyst A was packed lower-stage. An upper-stage desulfurization reaction was conducted using feed oil, hydrogen sulfide reduction treatment was then performed, and a lower-stage desulfurization reaction was conducted. The sulfur concentrations of the resulting partially desulfurized oil and refined oil are shown in Table 4.

### Comparative Example 2

100 mL of catalyst B was packed upper-stage and another 100 mL of catalyst B was packed lower-stage. An upper-stage desulfurization reaction was conducted using feed oil, hydrogen sulfide reduction treatment was then performed, and a lower-stage desulfurization reaction was conducted. The sulfur concentrations of the resulting partially desulfurized oil and refined oil are shown in Table 4.

### Comparative Example 3

100 mL of catalyst A was packed upper-stage and 100 mL of catalyst B was packed lower-stage. An upper-stage desulfurization reaction was conducted using feed oil, after which a lower-stage desulfurization reaction was conducted without any hydrogen sulfide reduction treatment being performed by means of a stripping apparatus. The sulfur concentrations of the resulting partially desulfurized oil and refined oil are shown in Table 4.

TABLE 4

| | In Partially | | Introduced | | | |
|---|---|---|---|---|---|---|
| | Desulfurized Oil | | Lower-stage | | In Refined Oil | |
| | | Content of | | | | Content of |
| | Sulfur | polycyclic | Concentration | Ammonia | Sulfur | polycyclic |
| | content | aromatic compounds | of hydrogen | concentration | content | aromatic compounds |
| | (ppm) | (% by weight) | sulfide (mol %) | (mol %) | (ppm) | (% by weight) |
| Example | 904 | 3.82 | 0.61 | 0.061 | 34 | 1.8 |
| Comparative | 904 | 3.82 | 0.61 | 0.061 | 66 | 2.3 |
| Example 1 | | | | | | |
| Comparative | 2097 | 4.03 | 0.57 | 0.060 | 118 | 2.4 |
| Example 2 | | | | | | |
| Comparative | 904 | 3.82 | 4.30 | 0.081 | 285 | 2.6 |
| Example 3 | | | | | | |

In view of the above results, it is apparent that the desulfurization method according to the present invention can yield gas oil in which the sulfur content is 50 ppm or less and the polycyclic aromatic compound content is 2% or less.

The method for hydrorefining a light oil fraction according to the present invention is a method for hydrodesulfurizing hydrogen and partially desulfurized oil with a sulfur content of 2000 ppm or less into refined oil with a sulfur content of 50 ppm or less by reducing the amount of hydrogen sulfide contained in the hydrogen and partially desulfurized oil to 1.5 mol % or less in relation to the hydrogen, and introducing the hydrogen and partially desulfurized oil into a reactor packed with a hydrodesulfurization catalyst on which tungsten and nickel or cobalt are supported as metal components.

Deep desulfurization to a sulfur content of 50 ppm or less and hydrodesulfurization aimed at reducing the concentration of polycyclic aromatic compounds to 2% or less can be achieved under conditions of high productivity and without the use of special crude oil such as that with a low sulfur content by combining specific catalysts and reaction conditions. Consequently, it is possible to commercially produce gas oil for environmentally friendly automobiles, and other light oil fractions used in substrates.

1. A hydrodesulfurization method for hydrodesulfurizing partially desulfurized oil, which is a light oil fraction, to produce a refined oil with a sulfur content of 50 ppm or less, wherein the method comprises:
providing a reactor packed with a hydrodesulfurization catalyst comprising a carrier formed of a porous inorganic oxide and also comprising tungsten and at least one of nickel and cobalt supported on the carrier; and
introducing hydrogen and sulfur-containing partially desulfurized oil into the reactor and performing hydrodesulfurization therein,
wherein a sulfur content of the partially desulfurized oil is 2000 ppm or less, and a concentration of hydrogen sulfide in the partially desulfurized oil and hydrogen is 1.5 mol % or less with respect to the hydrogen.

2. The hydrodesulfurization method for a light oil fraction according to claim 1, wherein:
the hydrodesulfurization catalyst is a lower-stage hydrodesulfurization catalyst;
the method further comprises introducing hydrogen and feed oil constituting sulfur-containing light oil fraction into the reactor packed with an upper-stage hydrodesulfurization catalyst and performing hydrodesulfurization in order to obtain the partially desulfurized oil; and
the sulfur content of the feed oil is 1% or greater, and the upper-stage hydrodesulfurization catalyst comprises a carrier formed of a porous inorganic oxide and comprises molybdenum and at least one of nickel and cobalt supported on the carrier as metal components.

3. The hydrodesulfurization method for a light oil fraction according to claim 2, wherein a content of polycyclic aromatic compounds in the feed oil is 10% by weight or greater.

4. The hydrodesulfurization method according to claim 2, further comprising stripping treatment of the partially desulfurized oil obtained from a reactor packed with the upper-stage hydrodesulfurization catalyst.

5. The hydrodesulfurization method for a light oil fraction according to claim 1, wherein a content of polycyclic aromatic compounds in the partially desulfurized oil is 3% by weight or greater, and a content of polycyclic aromatic compounds in refined oil is 2% by weight or less.

6. The hydrodesulfurization method according to claim 5, wherein the carrier comprises silica-alumina.

7. A hydrodesulfurization catalyst for hydrodesulfurizing a light oil fraction, comprising:
a carrier formed of a porous inorganic oxide; and
tungsten and at least one of nickel and cobalt supported on the carrier,
wherein the catalyst is used to perform hydrodesulfurization whereby partially desulfurized oil comprising a light oil fraction with a sulfur content of 2000 ppm or less is desulfurized into refined oil with a sulfur content of 50 ppm or less, and hydrogen sulfide contained in the partially desulfurized oil and hydrogen introduced to the hydrodesulfurization is 1.5 mol % or less with respect to the hydrogen.

8. The hydrodesulfurization catalyst according to claim 7, wherein the carrier comprises silica-alumina.

9. A reaction apparatus for hydrodesulfurization of a light oil fraction, comprising:
an upper-stage reactor packed with a catalyst comprising a carrier formed of a porous inorganic oxide, and molybdenum and at least one of nickel and cobalt supported on the carrier;
a lower-stage reactor packed with a catalyst comprising a carrier formed of a porous inorganic oxide, and tungsten and at least one of nickel and cobalt supported on the carrier;
a stripping apparatus which is disposed between the upper-stage reactor and the lower-stage reactor and reduces a content of hydrogen sulfide in partially desulfurized oil obtained from the upper-stage reactor to 1.5 mol % or less with respect to hydrogen fed to the lower-stage reactor; and
a hydrogen feed apparatus which feeds hydrogen to both the upper-stage reactor and the lower-stage reactor.

10. The reaction apparatus for hydrodesulfurization according to claim 9, wherein a sulfur content of a partially desulfurized oil fed to the lower-stage reactor is 2000 ppm or less, and a concentration of hydrogen sulfide in the partially desulfurized oil and hydrogen is 1.5 mol % or less with respect to the hydrogen.
